(19) United States
(12) Patent Application Publication
(10) Pub. No.: US 2026/0006600 A1
(43) Pub. Date: Jan. 1, 2026

(54) WIRELESS COMMUNICATION DEVICES AND WIRELESS COMMUNICATION METHODS FOR COORDINATED SCHEDULING OF DYNAMIC/FLEXIBLE TDD AND/OR SBFD OPERATION

(71) Applicant: SHENZHEN TCL NEW TECHNOLOGY CO., LTD., Shenzhen, Guangdong (CN)

(72) Inventor: Shahid JAN, Shenzhen, Guangdong (CN)

(73) Assignee: SHENZHEN TCL NEW TECHNOLOGY CO., LTD., Shenzhen, Guangdong (CN)

(21) Appl. No.: 18/879,794

(22) PCT Filed: Sep. 29, 2022
(86) PCT No.: PCT/CN2022/122573

§ 371 Date: Dec. 29, 2024

(51) Int. Cl. H04W 72/12; H04L 5/14; H04W 72/0446; H04W 72/0453

(52) U.S. Cl. CPC H04W 72/12; H04L 5/14; H04W 72/0446; H04W 72/0453

(57) ABSTRACT

A method of coordinated scheduling for time frequency resources of dynamic/flexible time division duplex (TDD) operation and/or sub-band full duplex (SBFD) operation includes in a coordinated scheduling of a dynamic/flexible TDD and/or SBFD operation in same time slots/symbols, at least two neighbor base stations exchanging a relevant scheduling information with each other, wherein the relevant scheduling information includes a starting and a number of downlink (DL) and/or uplink (UL) slot formats, a starting and a number of resource blocks (RBs) for DL and/or UL sub-bands, and/or a time window assigned to the dynamic/flexible TDD and/or SBFD operation; and implementing, by the at least two neighbor base stations, a scheduling adaptation according to the relevant scheduling information.

### BACKGROUND OF DISCLOSURE

### 1. Field of the Disclosure

The present disclosure relates to the field of wireless communication systems, and more particularly, to wireless communication devices and wireless communication methods for dynamic/flexible time division duplex (TDD) and/or sub-band full duplex (SBFD) operation in 5G NR (new radio) communication system. More specifically, the present disclosure discusses coordinated scheduling for time/frequency resources, among the neighbor's base stations, which can be applied to the implementation of dynamic/flexible TDD and SBFD operations in the same time slots/symbols. In addition, the present disclosure discusses spatial domain coordination among the neighbor's base stations which is common to dynamic/flexible TDD operation and SBFD operation.

### 2. Description of the Related Art

The diversified use cases and exponential growth of number of UEs in the next generation wireless communication system have increased the data traffic explosively which leads to the high requirements of spectral efficiency. In order to accomplish the requirements of high spectral efficiency, TDD system is widely adopted in commercial NR deployments. TDD system uses a single spectrum (frequency band) for downlink (DL) and uplink (UL) in different time slots, and utilizes the available spectrum more efficiently as compared to the frequency division duplex (FDD) system.

In conventional TDD system, the time domain resources are split between the DL, UL and flexible slots/symbols, where the flexible slots/symbols can be used as DL, UL or as a guard period for DL-UL switching. Allocation of a limited time duration for uplink in conventional TDD would result in reduced coverage, increased latency and reduced capacity. In order to enhance the limitations of conventional TDD operation, 3GPP RAN working group approves a study item [1] in Rel-18, which focus on the feasibility of simultaneous existence of DL and UL, as known as full duplex, or more specifically, sub-band non-overlapping full duplex operation within a conventional TDD band. In SBFD operation, gNB is operated in full duplex, i.e., the simultaneous DL and UL transmission occurs at gNB side only while the UE operates in half duplex. The study item specifies the RAN1 objectives regarding the sub-band non-overlapping full duplex and dynamic/flexible TDD operation.

In addition, the study item [1] mentioned to study the potential enhancement on dynamic/flexible TDD, as in 5G cellular network there may exist legacy UEs (which uses dynamic/flexible TDD) and Rel-18 UEs (which may use dynamic/flexible TDD or SBFD operation) simultaneously. This existence of legacy UEs and Rel-18 UEs serving by the neighbor's base stations may create co-channel gNB to gNB cross link interference (CLI), UE to UE CLI, UE to gNB CLI and gNB to UE CLI as shown in FIG. 1 and FIG. 2, wherein FIG. 1 illustrates a dynamic/flexible TDD (DL) operation and SBFD operation CLI analysis and FIG. 2 illustrates a dynamic/flexible TDD (UL) operation's and SBFD operation's CLI analysis. Furthermore, the existence of legacy UEs and Rel-18 UEs under the coverage of one serving base station may also face issues in simultaneous scheduling of time/frequency resources for DL or UL transmission. Therefore, to handle gNB to gNB, UE to UE, gNB to UE and UE to gNB CLIs between the legacy base stations and SBFD capable base stations or legacy UEs and Rel-18 UEs, an idea related to coordinated scheduling for time/frequency resources was discussed in 3GPP RAN1 #110 meeting, as given in the agreements. The agreements study the feasibility and potential benefits of coordinated scheduling for time/frequency resources between gNBs for gNB-to-gNB co-channel CLI handling which can be specific for dynamic/flexible TDD and/or common for both SBFD and dynamic/flexible TDD, the study at least includes: details of coordinated scheduling for time/frequency resources and/or relevant information exchange.

Regarding the coordinated scheduling for time/frequency resources among gNBs, and the spatial domain coordination among gNBs, for gNB to gNB CLI handling and UE to UE CLI handling, the coordination details for time/frequency resources, and in the spatial domain are still under discussion and there is no concrete proposal to address this issue. In addition, the existence of legacy UEs and Rel-18 UEs under the same base station, where the legacy UEs may use dynamic/flexible TDD and the Rel-18 UEs may use SBFD operation, may face issues in scheduling in the same time slots/symbols.

Therefore, there is a need for wireless communication devices and wireless communication methods for dynamic/flexible time division duplex (TDD) and/or sub-band full duplex (SBFD) operation, to study the coordinated scheduling for time/frequency resources, and spatial domain coordination among gNBs to handle gNB to gNB CLI and UE and UE CLI.

### SUMMARY

An object of the present disclosure is to propose wireless communication devices and wireless communication methods for dynamic/flexible time division duplex (TDD) and/or sub-band full duplex (SBFD) operation, to study the coordinated scheduling for time/frequency resources, and spatial domain coordination among gNBs to handle gNB to gNB CLI and UE and UE CLI.

In a first aspect of the present disclosure, a method of coordinated scheduling for time frequency resources of dynamic/flexible time division duplex (TDD) and/or sub-band full duplex (SBFD) operation includes in a coordinated scheduling of a dynamic/flexible TDD and/or SBFD operation in same time slots/symbols, at least two neighbor base stations exchanging a relevant scheduling information with each other, wherein the relevant scheduling information comprises a starting and a number of downlink (DL) and/or uplink (UL) slot formats, a starting and a number of resource blocks (RBs) for DL and/or UL sub-bands, and/or a time window assigned to the dynamic/flexible TDD and/or SBFD operation; and implementing, by the at least two neighbor base stations, a scheduling adaptation according to the relevant scheduling information.

In a second aspect of the present disclosure, a base station comprises a memory, a transceiver, and a processor coupled to the memory and the transceiver. The processor is configured to perform the above method.

In a third aspect of the present disclosure, a non-transitory machine-readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a dynamic/flexible TDD (DL) operation and SBFD operation CLI analysis.

FIG. 2 is a schematic diagram illustrating an example of a dynamic/flexible TDD (UL) operation's and SBFD operation's CLI analysis.

FIG. 3 is a block diagram of base stations (e.g., gNBs) of communication in a communication network system according to an embodiment of the present disclosure.

FIG. 4 is a flowchart illustrating a method of coordinated scheduling for time frequency resources of dynamic/flexible time division duplex (TDD) and/or sub-band full duplex (SBFD) operation according to an embodiment of the present disclosure.

FIG. 5 is a schematic diagram illustrating an example of scenario 1 of Dynamic/flexible TDD at gNB1 and SBFD operation at gNB2 according to an embodiment of the present disclosure.

FIG. 6 is a schematic diagram illustrating an example of scheduling adaptation of dynamic/flexible TDD (DL) at gNB1 and SBFD operation at gNB2 according to an embodiment of the present disclosure.

FIG. 7 is a schematic diagram illustrating an example of scheduling adaptation of dynamic/flexible TDD (UL) at gNB1 and SBFD operation at gNB2 according to an embodiment of the present disclosure.

FIG. 8 is a schematic diagram illustrating an example of scenario 2 of both dynamic/flexible TDD and SBFD operation's at gNB1 and gNB2 according to an embodiment of the present disclosure.

FIG. 9 is a schematic diagram illustrating an example of scheduling adaptation of same direction dynamic/flexible TDD (DL) and SBFD operation at gNB1 and gNB2 according to an embodiment of the present disclosure.

FIG. 10 is a schematic diagram illustrating an example of scheduling adaptation of different direction dynamic/flexible TDD (DL-UL) and SBFD operation at gNB1 and gNB2 according to an embodiment of the present disclosure.

FIG. 11 is a schematic diagram illustrating an example of scenario 3 of dynamic/flexible TDD and SBFD operation at gNB1, and SBFD operation at gNB2 according to an embodiment of the present disclosure.

FIG. 12 is a schematic diagram illustrating an example of scheduling adaptation of dynamic/flexible TDD (DL) at gNB1 and SBFD operation at gNB2 according to an embodiment of the present disclosure.

FIG. 13 is a schematic diagram illustrating an example of scheduling adaptation of dynamic/flexible TDD (UL) at gNB1 and SBFD operation at gNB2 according to an embodiment of the present disclosure.

FIG. 14 is a schematic diagram illustrating an example of transparent muted RBs according to an embodiment of the present disclosure.

FIG. 15 is a schematic diagram illustrating an example of non transparent muted RBs according to an embodiment of the present disclosure.

FIG. 16 is a schematic diagram illustrating an example of time window for dynamic/flexible TDD or SBFD operation in terms of slots according to an embodiment of the present disclosure.

FIG. 17 is a schematic diagram illustrating an example of time window for dynamic/flexible TDD or SBFD operation in terms of OFDM symbols according to an embodiment of the present disclosure.

FIG. 18 is a schematic diagram illustrating an example of spatial domain enhancement for dynamic/flexible TDD and SBFD operation according to an embodiment of the present disclosure.

FIG. 19 is a block diagram of a system for wireless communication according to an embodiment of the present disclosure.

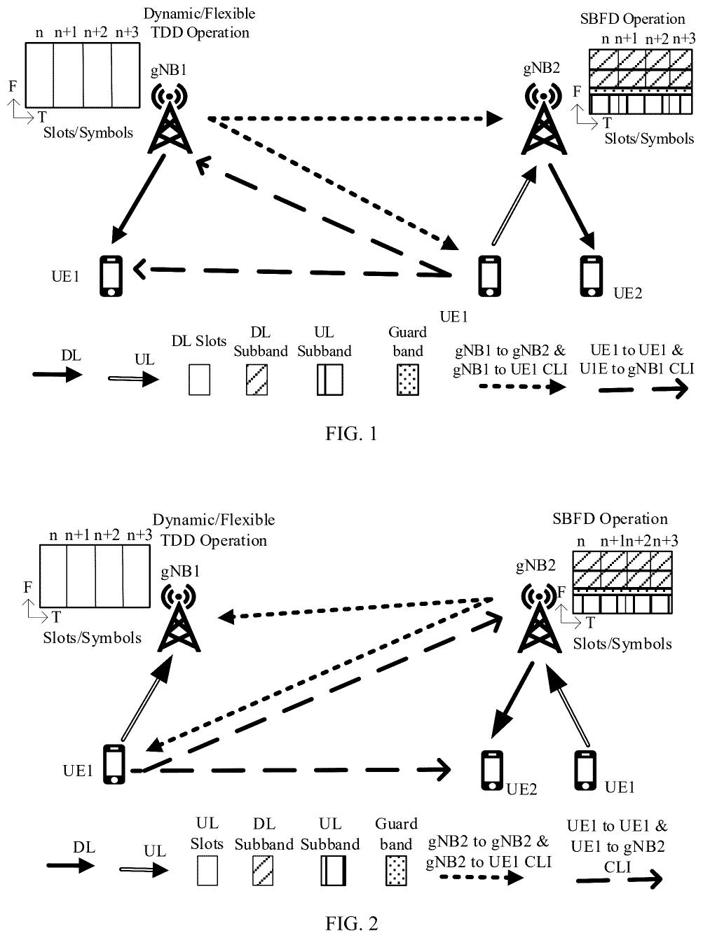

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Some embodiments of this disclosure study the details of coordinated scheduling for time/frequency resources, and spatial domain coordination among gNBs to handle gNB to gNB CLI and UE and UE CLI. For examples, some embodiments of this disclosure study identified problems on that: In 5G NR communications system, the scheduling of legacy UEs (which may use dynamic/flexible TDD) and Rel-18 UEs (which may use dynamic/flexible TDD or SBFD operation) in the same time slots/symbols may face the following challenges. 1. When the legacy UEs and Rel-18 UEs are serving by one base station, then how to perform both operations simultaneously i.e., TDD operation and SBFD operation in the same time slots/symbols. 2. When the legacy UEs and Rel-18 UEs are serving by different base stations in the same time slots, which scheduling adaptation rules shall be applied to implement the coordinated scheduling and handle gNB to gNB, and UE to UE CLI. In addition, what relevant information's needs to be exchange among the neighbor gNBs in order to implement scheduling adaptation and coordinate in spatial domain.

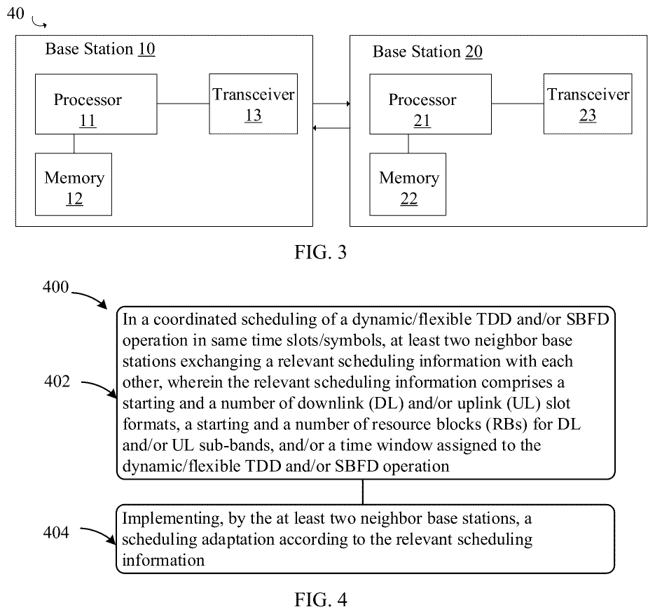

FIG. 3 illustrates that, in some embodiments, base stations (e.g., gNBs) 10 and 20 for communication in a communication network system 40 according to an embodiment of the present disclosure are provided. The communication network system 40 includes the base stations 10 and 20. The base station 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

FIG. 4 illustrates a method 400 of coordinated scheduling for time frequency resources of dynamic/flexible time division duplex (TDD) and/or sub-band full duplex (SBFD) operation according to an embodiment of the present disclosure. In some embodiments, the method 400 includes: a block 402, in a coordinated scheduling of a dynamic/flexible TDD and/or SBFD operation in same time slots/symbols, at least two neighbor base stations exchanging a relevant scheduling information with each other, wherein the relevant scheduling information comprises a starting and a number of downlink (DL) and/or uplink (UL) slot formats, a starting and a number of resource blocks (RBs) for DL and/or UL sub-bands, and/or a time window assigned to the dynamic/flexible TDD and/or SBFD operation, and a block 404, implementing, by the at least two neighbor base stations, a scheduling adaptation according to the relevant scheduling information. Further, the processor 11 and/or or 21 is configured to perform the above method 400.

In some embodiments, the relevant scheduling information is exchange between the at least two neighbor base stations via a backhaul signaling using an Xn interface or through over the air (OTA) signaling. In some embodiments, the at least two neighbor base stations are configured to implement the dynamic/flexible TDD operation and the SBFD operation respectively in the same time slots/symbols. In some embodiments, the relevant scheduling information shared by the at least two neighbor base stations comprises a starting and a number of slots/symbols for DL and/or UL transmission of the dynamic/flexible TDD operation and/or a starting and a number of RBs for DL and/or UL transmission of the dynamic/flexible TDD operation; and/or the relevant scheduling information shared by the at least two neighbor base stations comprises a starting and a number of slots/symbols for DL and/or UL sub-bands and/or a staring and a number of RBs for DL and/or UL sub-bands.

In some embodiments, a first base station of the at least two neighbor base stations is configured to perform DL transmission in the same time slots/symbols, and a second base station of the at least two neighbor base stations is configured to perform DL and UL transmissions using DL and UL sub-bands in the same time slots/symbols, and implementing the scheduling adaptation comprises at least one of the followings: wherein the first base station is configured to mute or halt the number of RBs which corresponds to the RBs of the UL sub-band of at least one neighbor base station; and wherein the second base station is configured to assign more sub-bands resources to a DL sub-band transmission to minimize a number of muting RBs at the first base station, wherein the muted or halted RBs are used for UL transmission or sounding reference signals in case the at least two neighbor base stations support both the dynamic/flexible TDD and SBFD operation.

In some embodiments, wherein a first base station of the at least two neighbor base stations is configured to perform UL transmission in the same time slots/symbols, and a second base station of the at least two neighbor base stations is configured to perform DL and UL transmissions in the same time slots/symbols for the SBFD operation, and implementing the scheduling adaptation comprises at least one of the followings: wherein the second base stations are configured to mute or halt the number of RBs which corresponds to the RBs of the DL sub-band at the first base station; and wherein the second base station is configured to assign more sub-bands resources to an UL sub-band transmission to minimize a number of muting RBs at the first base station.

In some embodiments, the at least two neighbor base stations are configured to implement both the dynamic/flexible TDD operation and the SBFD operation in the same flexible time slots/symbols. In some embodiments, each of the at least two neighbor base stations uses time windows for each of the dynamic/flexible TDD operation and the SBFD operation, and the relevant scheduling information comprises: X slots or Y orthogonal frequency division multiplexing (OFDM) symbols in a first time window and X slots or Y OFDM symbols in a second time window; a time window assignment to both the dynamic/flexible TDD operation and the SBFD operation; and/or a staring and a number of RBs for DL and UL sub-bands in a time window which is assigned to the SBFD operation. In some embodiments, if the at least two neighbor base stations perform the dynamic/flexible TDD operation in the same transmission direction, implementing the scheduling adaptation comprises at least one of the followings: wherein a first base station of the at least two neighbor base stations is configured to assign the first time window to the dynamic/flexible TDD operation and the second time window to the SBFD operation, and wherein a second base station of the at least two neighbor base stations is configured to assign the first time window to the dynamic/flexible TDD operation and the second time window to the SBFD operation.

In some embodiments, if the at least two neighbor base stations perform the dynamic/flexible TDD operation in different transmission directions, implementing the scheduling adaptation comprises at least one of the followings: wherein a first base station of the at least two neighbor base stations is configured to assign the first time window to the dynamic/flexible TDD operation and the second time window to the SBFD operation, and wherein a second base station of the at least two neighbor base stations is configured to assign the first time window to the SBFD operation and the second time window to the dynamic/flexible TDD operation. In some embodiments, the first base station is configured to assign more sub-bands resources to the UL direction in the second time window and mute or halt the RBs in the first time window which corresponds to the UL direction at the second base station, and/or wherein the second base station is configured to assign more sub-bands resources to the DL direction in the first time window and mute or halt those RBs in the second time window which corresponds to the DL transmission at the first base station.

In some embodiments, a first base station of the at least two neighbor base stations is configured to implement both the dynamic/flexible TDD operation and the SBFD operation in the same flexible time slots/symbols, and a second base station of the at least two neighbor base stations is configured to implement only the SBFD operation in the same flexible time slots/symbols. In some embodiments, the relevant scheduling information shared by the at least two neighbor base stations comprises X slots or Y symbols in the first time window and X slots or Y symbols in the second time window, a time window assignment to both the dynamic/flexible TDD operation and the SBFD operation, and/or a starting and a number of RBs for DL and UL sub-bands in a time window which is assigned for the SBFD operation; and/or the relevant scheduling information shared by the at least two neighbor base stations comprises a starting and a number of slots/symbols for DL and/or UL sub-bands and/or a staring and a number of RBs for DL and/or UL sub-bands.

In some embodiments, the dynamic/flexible TDD operation at the first base station of the at least two neighbor base stations is in the DL direction, implementing the scheduling adaptation comprises at least one of the followings: wherein the first base station is configured to assign the first time window to the dynamic/flexible TDD operation and the second time window to the SBFD operation and/or the first base station is configured to mute or halt the number of RBs in the first time window which corresponds to the UL sub-band direction at the second base station, and wherein the second base station is configured to assign sub-bands resources to the DL direction. In some embodiments, the dynamic/flexible TDD operation at the first base station is in the UL direction, implementing the scheduling adaptation comprises at least one of the followings: wherein the first base station is configured to assign the first time window to the dynamic/flexible TDD operation and the second time window to the SBFD operation and/or the first base station is configured to mute or halt the number of RBs in the first time window which corresponds to the DL sub-band direction at the second base station, and wherein the second base station is configured to assign sub-bands resources to the UL direction.

In some embodiments, implementing the scheduling adaptation comprises muting or halting the RBs in the dynamic/flexible TDD operation which corresponds to an opposite transmission sub-bands direction of the second base station. In some embodiments, the muting or halting RBs are invisible/transparent to UEs or visible/non-transparent to the UEs. In some embodiments, when the muting or halting RBs are invisible/transparent to UEs, muting or halting the RBs in the dynamic/flexible TDD operation is through a resource allocation type 1, where an RB_start of the resource allocation type 1 is adjusted according to the relevant scheduling information received from the second base station.

In some embodiments, when the muting or halting RBs are visible/non-transparent to the UEs, muting or halting the RBs in the dynamic/flexible TDD operation is through a resource allocation type 0, where a bitmap is used to indicate resource block groups (RBGs). In some embodiments, the base station is used to configure all the RBs to the UE and send an indication to inform the UE that a number of RBs or resource block groups (RBGs) cannot be use for transmission. In some embodiments, the time window comprises slots/symbols to allow the first base station to perform the dynamic/flexible TDD operation and/or the SBFD operation, and/or the time window is periodic or aperiodic. In some embodiments, the time window comprises a slot based time window or a symbol based time window.

In some embodiments, the slot based time window comprises a reference point and a duration, the reference point of the slot based time window is determined by a slot-level offset form a start of a sub-frame which is associated with the slot based time window, and the duration is a number of slots until which the slot based time window is effective. In some embodiments, the symbol based time window comprises a reference point and a duration, the reference point of the symbol based time window is determined by a symbol-level offset from a start of a sub-frame which is associated with the symbol based time window, and the duration is a number of symbols until which the symbol based time window is effective. In some embodiments, a configuration of the time window for the dynamic/flexible TDD operation and/or the SBFD operation is performed by using an RRC signaling. In some embodiments, the method further comprises performing coordination for spatial domain in which the base station and the at least neighbor base station share the relevant scheduling information of serving beams for DL transmission and UL reception to isolates the transmission and reception beams.

Some embodiments of this disclosure discuss coordinated scheduling for time/frequency resources of dynamic/flexible TDD and SBFD operations among the neighbor base stations, and the spatial domain coordination among the neighbor gNBs for dynamic/flexible TDD and SBFD operation, wherein the neighbor base stations may serve legacy UEs and SBFD UEs in the same time slots/symbols. In addition, some embodiments of this disclosure focus on the simultaneous existence of legacy UEs and SBFD UEs under the coverage of the same base station.

Some embodiments explain the coordinated scheduling details of time/frequency resources for dynamic/flexible TDD and SBFD operation. Some embodiments explain the spatial domain coordination among the neighbor gNBs for dynamic/flexible TDD and SBFD operation.

### Coordinated Scheduling for Time/Frequency Resources

This embodiment of the present disclosure presents the details of coordinated scheduling for time/frequency resources to implement dynamic/flexible TDD and SBFD operation in the same time slots and handle gNB to gNB CLI and UE to UE CLI. In coordinated scheduling of dynamic/flexible TDD and SBFD operations, two or more than two neighbor base stations exchange the relevant scheduling information with each other, such as the starting and numbers of the DL/UL slots format, the starting and number of RBs for DL or UL sub-bands, the time window assigned to dynamic/flexible TDD or SBFD operation, and implement the scheduling adaptation according to the relevant scheduling information, in order to minimize or avoid the gNB to gNB CLI, UE to UE CLI, gNB to UE CLI, and UE to gNB CLI before happening.

In coordinated scheduling of dynamic/flexible TDD and SBFD operation, the scheduling adaptation of time/frequency resources for dynamic/flexible TDD and SBFD operation can be performed according to the implementation of dynamic/flexible TDD and SBDF operations in the neighbor base stations. In other words, the scheduling adaptation solutions among the neighbor base stations may varies from one scenario to another scenario according to the DL or UL transmission directions of dynamic/flexible TDD and SBFD operation, and/or according to the existence of dynamic/flexible TDD and SBFD operation in one or more base stations.

For this reason, this embodiment of the present disclosure discusses the following scenarios and proposes several coordinated scheduling adaptation solutions to target the reduction or avoiding of gNB to gNB CLI, UE to UE CLI, gNB to UE CLI and UE to UE CLI.

### Scenario 1

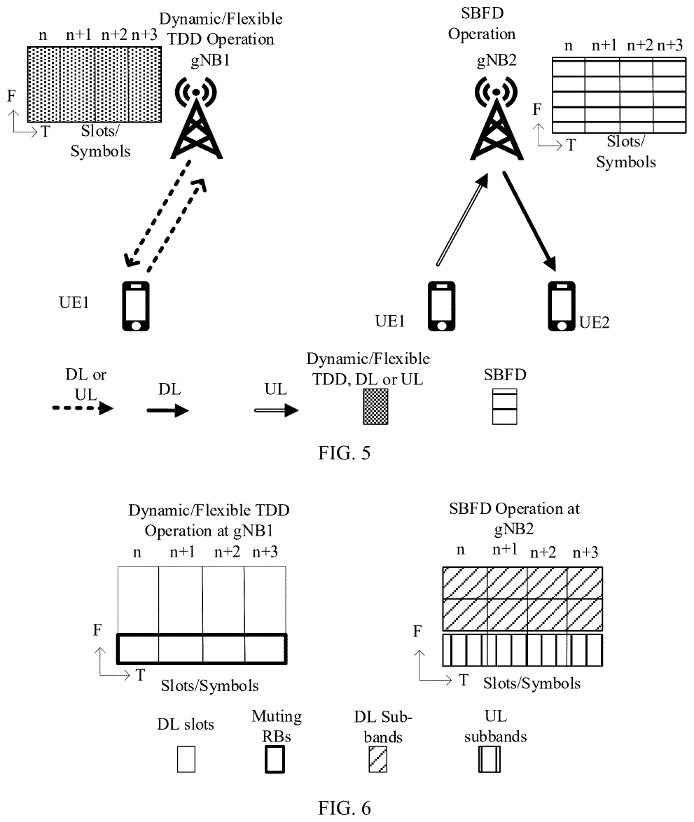

FIG. 5 is a schematic diagram illustrating an example of scenario 1 of dynamic/flexible TDD at gNB1 and SBFD operation at gNB2 according to an embodiment of the present disclosure. FIG. 5 illustrates that, in some embodiments, in scenario 1, assume two neighbor gNBs as illustrated in FIG. 5, wherein gNB1 performs dynamic/flexible TDD operation and, gNB2 performs SBFD operation in the same time slots i.e., slot n, n+1, n+2 and n+3. It can be noted that the time slots/symbols considered by some embodiments of this disclosure is the flexible time slots/symbols, which can be used for dynamic/flexible TDD operation (DL or UL direction) and/or SBFD operation.

In order to perform coordinated scheduling of time/frequency resources for dynamic/flexible TDD and SBFD operations in scenario 1, the following relevant scheduling information needs to be exchange between gNB1 and gNB2 via backhaul signaling using Xn interface or through over the air (OTA) signaling.

gNB1 Shares With gNB2
1. Starting and Numbers of slots for DL or UL transmission of dynamic/flexible TDD.
2. Starting and Numbers of RBs for DL or UL transmission of dynamic/flexible TDD.
   gNB2 Shares With gNB1
1. Starting and Numbers of slots for DL or UL sub-bands.
2. Staring and Numbers of RBs for DL and UL sub-bands.

Based on the relevant scheduling information exchange, the neighbor gNBs can perform scheduling adaptation according to the DL or UL directions of dynamic/flexible TDD as explained below.

### Case 1

FIG. 6 is a schematic diagram illustrating an example of scheduling adaptation of dynamic/flexible TDD (DL) at gNB1 and SBFD operation at gNB2 according to an embodiment of the present disclosure. FIG. 6 illustrates that, in some embodiments, in case1, gNB1 performs DL transmission in slots n, n+1, n+2, and n+3, and gNB2 performs DL and UL transmission using DL and UL sub-bands in slots n, n+1, n+2, and n+3. In order to minimize or avoid the CLI, gNB1 and gNB2 can implement the following scheduling adaptation as shown in FIG. 6.
1. gNB1 can mute or halt the number of RBs (according to the methods disclosed in above embodiments) which corresponds to the RBs of the UL sub-band at gNB2 as shown in FIG. 6.
2. gNB2 can assign more sub-bands resources to the DL sub-band transmission to minimize the number of muting RBs at gNB1 e.g., gNB2 assign two sub-bands to the DL transmission as shown in FIG. 6.

Note: The muted or halted RBs can be used for UL transmission, or sounding reference signals in case the UEs and base station both supports SBFD operation.

### Case 2

FIG. 7 is a schematic diagram illustrating an example of scheduling adaptation of

dynamic/flexible TDD (UL) at gNB1 and SBFD operation at gNB2 according to an embodiment of the present disclosure.

In case 2, gNB1 performs UL transmission using slots n, n+1, n+2 and n+3, and gNB2 performs DL and UL transmission using slot n, n+1, n+2 and n+3 for SBFD operation, then gNB1 and gNB2 can implement the following scheduling adaptation.
1. gNB1 can mute or halt the number of RBs (according to the methods explained in the above embodiments) which corresponds to the RBs of the DL sub-band at gNB2 as shown in FIG. 7.
2. gNB2 can assign more sub-bands resources to the UL sub-band transmission to minimize the number of muting RBs at gNB1 e.g., gNB2 assigns two sub-bands to the UL transmission as shown in FIG. 7.

### Scenarios 2

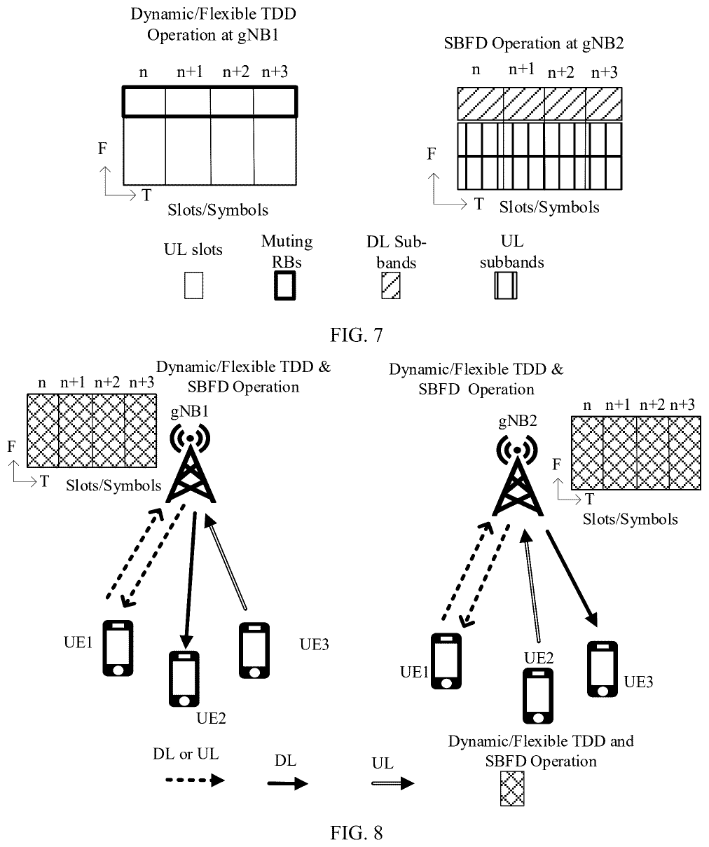

FIG. 8 is a schematic diagram illustrating an example of scenario 2 of both dynamic/flexible TDD and SBFD operation's at gNB1 and gNB2 according to an embodiment of the present disclosure. FIG. 8 illustrates that, in some embodiments, in scenario 2, assume two neighbor gNBs uses dynamic/flexible TDD and SBFD operation at the same time slots simultaneously, e.g., both gNB1 and gNB2 uses dynamic/flexible TDD and SBFD operation in the time slots n, n+1, n+2 and n+3, to serves the legacy UEs and SBFD UEs simultaneously as shown in FIG. 8.

Since in this scenario each gNB performs both dynamic/flexible TDD and SBFD operation at the flexible time slots. Therefore, each gNB will use time windows for each operation (as disclosed in the above embodiments). In addition, for coordinated scheduling of time/frequency resources for dynamic/flexible TDD and SBFD operation, gNB1 and gNB2 can shares the following relevant information exchange with each other through backhaul signaling's using Xn interface or through OTA signaling.
1. Number of X number of slots or Y number of OFDM symbols in time window 1 and numbers of X numbers of slots or Y numbers of OFDM symbols in time window 2.
2. Time window assignment to both operation (i.e., which time window is assigned to which operation).
3. Staring and Numbers of RBs for DL and UL sub-bands in a time window which is assigned to SBFD operation.

Based on the above mentioned relevant scheduling information exchange, gNB1 and gNB2 can perform the following scheduling adaptation, according to the DL and UL transmission direction of dynamic/flexible TDD operation at both gNBs.

### Case 1

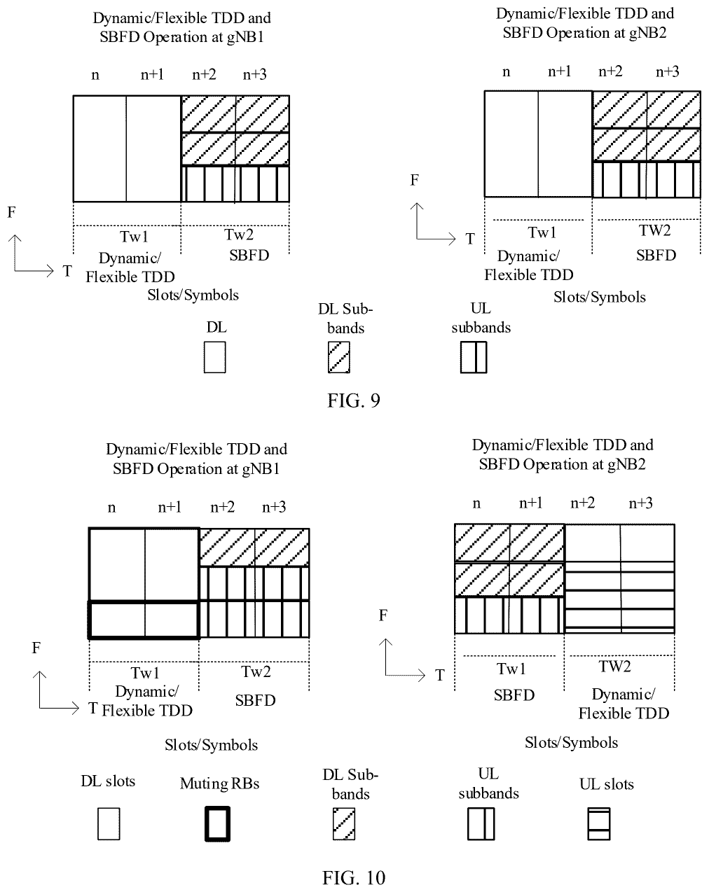

FIG. 9 is a schematic diagram illustrating an example of scheduling adaptation of same direction dynamic/flexible TDD (DL) and SBFD operation at gNB1 and gNB2 according to an embodiment of the present disclosure. FIG. 9 illustrates that, in some embodiments, in case 1, if both gNB1 and gNB2 performs dynamic/flexible TDD in the same transmission direction e.g., DL direction then gNB1 and gNB2 can perform the following scheduling adaptation as shown in FIG. 9.

Note: This scheduling adaptation implementation can also be applied when both gNB1 and gNB2 performs dynamic/flexible TDD in UL transmission direction.
1. gNB1 assigns time window Tw1 to the dynamic/flexible TDD operation and time window Tw2 to the SBFD operation as shown in FIG. 9.
2. gNB2 assigns the time window Tw1 to the dynamic/flexible TDD operation and time window Tw2 to the SBFD operation as shown in FIG. 9.

### Case 2

FIG. 10 is a schematic diagram illustrating an example of scheduling adaptation of different direction dynamic/flexible TDD (DL-UL) and SBFD operation at gNB1 and gNB2 according to an embodiment of the present disclosure. FIG. 10 illustrates that, in some embodiments, in case 2, the DL or UL direction of dynamic/flexible TDD at both gNBs are different i.e., gNB1 operate dynamic/flexible TDD in DL direction, and gNB2 operates the dynamic/flexible TDD in UL direction. In this case, the alternate time windows can be assigned to the dynamic/flexible TDD and SBFD operation at gNB1 and gNB2 with the following scheduling adaptation rules.
1. gNB1 assigns time window Tw1 to the dynamic operation and time window Tw2 to the SBFD operation. In addition, gNB1 assign more sub-bands resources i.e., two sub-bands to the UL direction in time window 2 and mute or halt those RBs in time window1 which corresponds to the UL sub-band direction at gNB2 as shown in FIG. 10.
2. gNB2 assigns time window Tw1 to the SBFD operation and time window Tw2 to the dynamic/flexible TDD operation. In addition, gNB2 assign more sub-bands resources i.e., two sub-bands to the DL direction in time window 1, and mute or halt those RBs in time window2 which corresponds to the DL sub-bands at gNB1 as shown in FIG. 10.

### Scenario 3

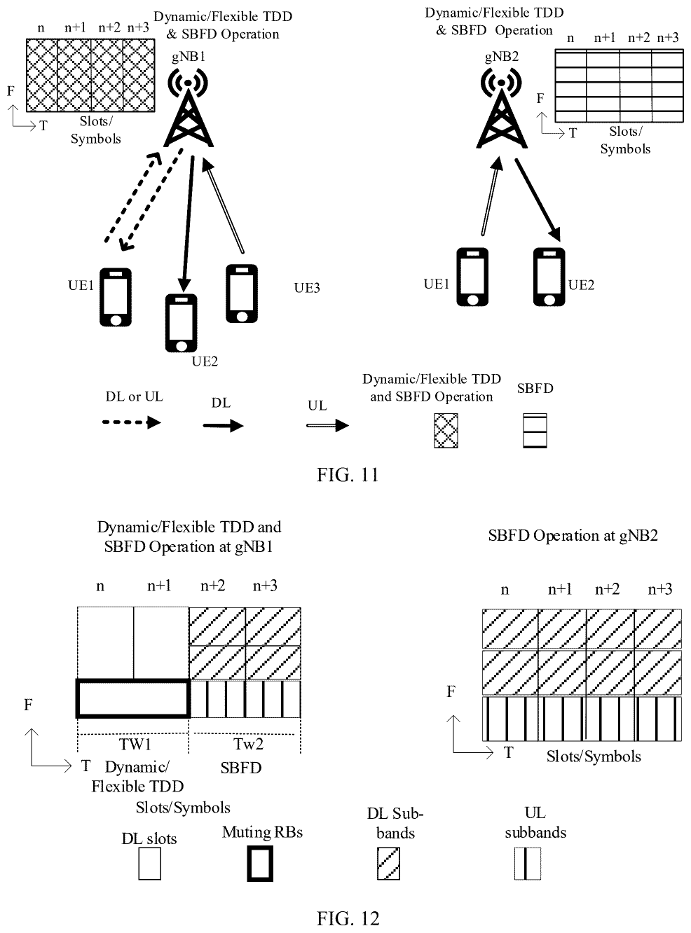

FIG. 11 is a schematic diagram illustrating an example of scenario 3 of dynamic/flexible TDD and SBFD operation at gNB1, and SBFD operation at gNB2 according to an embodiment of the present disclosure. FIG. 11 illustrates that, in some embodiments, in scenario 3, assume two gNBs as shown in FIG. 11, where gNB1 performs both dynamic/flexible TDD and SBFD operation at the same time slots/symbols. In other words, gNB2 performs dynamic/flexible TDD and SBFD operation by using the time slots n, n+1, n+2, and n+3 to serve the legacy UEs and SBFD UEs simultaneously. On the other hand, gNB2 uses slot n, n+1, n+2, and n+3 to perform the SBFD operation as shown FIG. 11.

Since gNB1 uses both dynamic/flexible TDD and SBFD operation at the same time slots, therefore gNB1 can define time window Tw1 and time window Tw2 for the two different operations i.e., dynamic/flexible TDD and SBFD operations. In addition, the following relevant scheduling information needs to be exchanged between gNB1 and gNB2 other through backhaul signaling using Xn interface or through OTA signaling.

gNB1 Shares With gNB2
1. Number of X slots or Y symbols in time window 1 and numbers of X slots or Y symbols in time window 2, and which time window is assigned to which operation. For instance, Tw1 is assigned to dynamic/flexible TDD operation and Tw2 is assigned to SBFD operation.
2. Starting and Numbers of RBs for DL and UL sub-bands in time window which is assigned for SBFD operation. (i.e., Tw2 in this case).
   gNB2 Shares With gNB1
1. Starting and Numbers of slots/symbols for DL or UL sub-bands.
2. Staring and Number of RBs for DL or UL sub-bands.

In order to minimize or avoid the CLI before happening the gNB1 and gNB2 can perform the following scheduling adaptation based on the relevant scheduling information exchange.

### Case 1

FIG. 12 is a schematic diagram illustrating an example of scheduling adaptation of dynamic/flexible TDD (DL) at gNB1 and SBFD operation at gNB2 according to an embodiment of the present disclosure. FIG. 12 illustrates that, in some embodiments, in case 1, the dynamic/flexible TDD at gNB1 is in DL direction then gNB1 and gNB2 can implement the following scheduling adaptation as shown in FIG. 12.
1. gNB1 can assign time window Tw1 to the dynamic operation and time window Tw2 to the SBFD operation. In addition, gNB1 mute or halt the number of RBs in time window Tw1 which corresponds to the UL sub-band direction at gNB2 as shown in FIG. 12.
2. gNB2 assign more sub-bands resources i.e., two DL sub-bands to the DL direction as shown in FIG. 12.

### Case 2

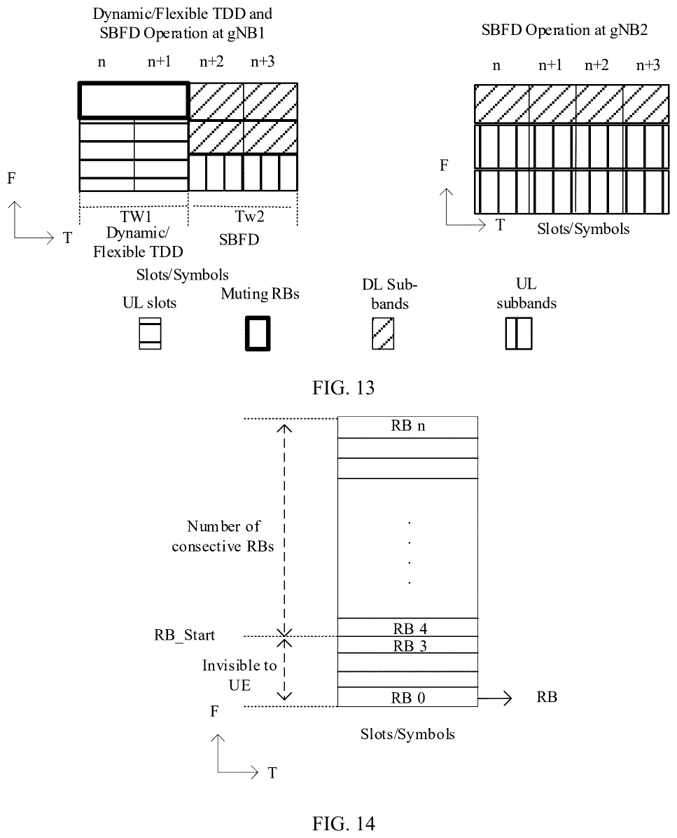

FIG. 13 is a schematic diagram illustrating an example of scheduling adaptation of dynamic/flexible TDD (UL) at gNB1 and SBFD operation at gNB2 according to an embodiment of the present disclosure. FIG. 13 illustrates that, in some embodiments, in case 2, the dynamic/flexible TDD at gNB1 is in UL direction, then gNB1 and gNB2 can implement the following scheduling adaptations as shown in FIG. 13.
1. gNB1 can assign time window Tw1 to the dynamic/flexible TDD operation and time window Tw2 to the SBFD operation (as disclosed in the above embodiments). In addition, gNB1 can mute or halt the numbers of RBs in time window Tw1 which corresponds to the DL sub-band direction at gNB2 as shown in FIG. 13.
2. gNB2 can assign more sub-bands resources i.e., two sub-bands to the UL direction as shown in FIG. 13.

### Muting/Halting the RBs

This embodiment of the present disclosure discusses two approaches to implement the muting of resources blocks (RBs) in dynamic/flexible TDD operation which corresponds to the opposite transmission sub-bands direction of the neighbor base station. This muting RBs procedure is similar for all those embodiments of the present disclosure, where it is applied.

### Transparent Muted RBs

FIG. 14 is a schematic diagram illustrating an example of transparent muted RBs according to an embodiment of the present disclosure. FIG. 14 illustrates that, in some embodiments, in this method, the muting RBs are invisible/transparent to the UEs as shown in FIG. 14. Implementation: Muting RBs through this method can be implemented through the resource allocation type 1 of the current specification [TS 38.214], where the RB_start of the resource allocation type 1 can be adjusted according to the scheduling information received from the neighbour gNBs.

For instance, if the neighbor gNB is using the first four RBs (from RB0 to RB3) for opposite direction transmission i.e., DL sub-band or UL sub-band. The RB_Start of the resource allocation type 1 can be started from RB4 as shown in FIG. 14.

### Non Transparent Muted RBs

In this method, the muted RBs are visible/non-transparent to the UE. In this embodiment the gNB can configure all the RBs to the UE and then send an indication to inform the UE that a number of RBs or resource block groups (RBGs) cannot be use for transmission.

### Implementation

Muting RBs through this method can be implemented by using the resource allocation type 0 of the current specification [TS 38.214], where bitmap is used to indicate the Resource block groups (RBG). In this embodiment the muted RBs can be visible to the UE.

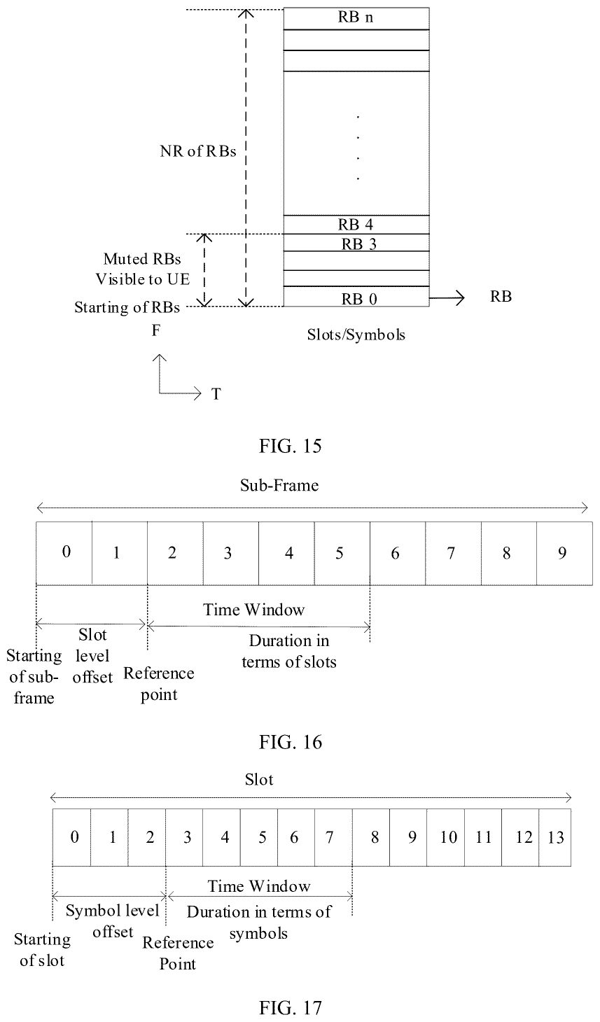

FIG. 15 is a schematic diagram illustrating an example of non transparent muted RBs according to an embodiment of the present disclosure. FIG. 15 illustrates that, for instance, if the neighbor gNB is using the first four RBs (from RB0 to RB3) for opposite direction transmission i.e., DL sub-band or UL sub-band. The bitmap of resource allocation type 0 can indicate the UE to use the RBs starting from RB4 to RBn. Similarly, the bitmap of resource allocation type 0 can indicate the UE that the RBs from RB0 to RB3 are muted and it shall not be used by that specific UE for transmission as shown in FIG. 15.

### Time Window for Dynamic/Flexible TDD and SBFD Operations

FIG. 16 is a schematic diagram illustrating an example of time window for dynamic/flexible TDD or SBFD operation in terms of slots according to an embodiment of the present disclosure. FIG. 16 illustrates that, this embodiment of the present disclosure proposes, time windows operation which can be assigned by a gNB for dynamic/flexible TDD operation and SBFD operation. The time window can be defined in terms of slots in a sub-frame or in terms of OFDM symbols in a slot as explained below. Slots based time window: The time window for dynamic/flexible TDD operation and/or SBFD operation can be define in terms of NR slots in a sub-frame, comprises of; a reference point and a duration as shown in FIG. 16.

The reference point of a time window is determined by a slot-level offset form the start of the sub-frame which is associated with the time window, and the duration is the number of slots until which the time window is effective as shown in FIG. 16. The duration of time window may comprise of X numbers of slots in a sub frame, where X is an integer in the range of {1, 2 . . . 10} slots. The duration of time window in terms of time slots may varies according to the implementation scenarios of dynamic/flexible TDD and/or SBFD operation in a base station. For instance, a time window comprises of 4 slots duration and starting from the 2nd slot of a sub-frame with a 2 slots level offset from the start of the sub-frame is illustrated in FIG. 16.

FIG. 17 is a schematic diagram illustrating an example of time window for dynamic/flexible TDD or SBFD operation in terms of OFDM symbols according to an embodiment of the present disclosure. Symbols based time window: In the same way, the time window for dynamic/flexible TDD and/or SBFD operation can be define in terms of OFDM symbols in a slot, which comprise of reference point and duration. In symbol based time window the reference point is determined by an OFDM symbol-level offset form the start of a slot which is associated with the time window, and the duration is the number of OFDM symbols until which the time window is effective as shown in FIG. 17.

Similar to the slots base time window, the duration of symbol level time window may comprise of Y numbers of OFDM symbols in a slot, where Y is an integer in the range of {1, 2 . . . 14} symbols. The duration of time window in terms of OFDM symbol may varies according to the implementation scenarios of dynamic/flexible TDD and/or SBFD operation in a base station. For instance, a time window comprises of 5 OFDM symbols duration and starting from the 2nd slot of a slot with 3 symbols level offset from the start of the slot is illustrated in FIG. 17.

### Configuration of Time Window

The configuration of time window for dynamic/flexible TDD operation and/or SBFD operation can be performed by using the existing RRC signaling i.e., TDD-UL-DL-ConfigCommon and TDD-UL-DL-ConfigDedicated or new RRC signaling's can be defined to configure the time windows to UE for dynamic/flexible TDD and/or SBFD operation. In addition, the configured time window can be periodic or aperiodic.

### Spatial Domain Coordination

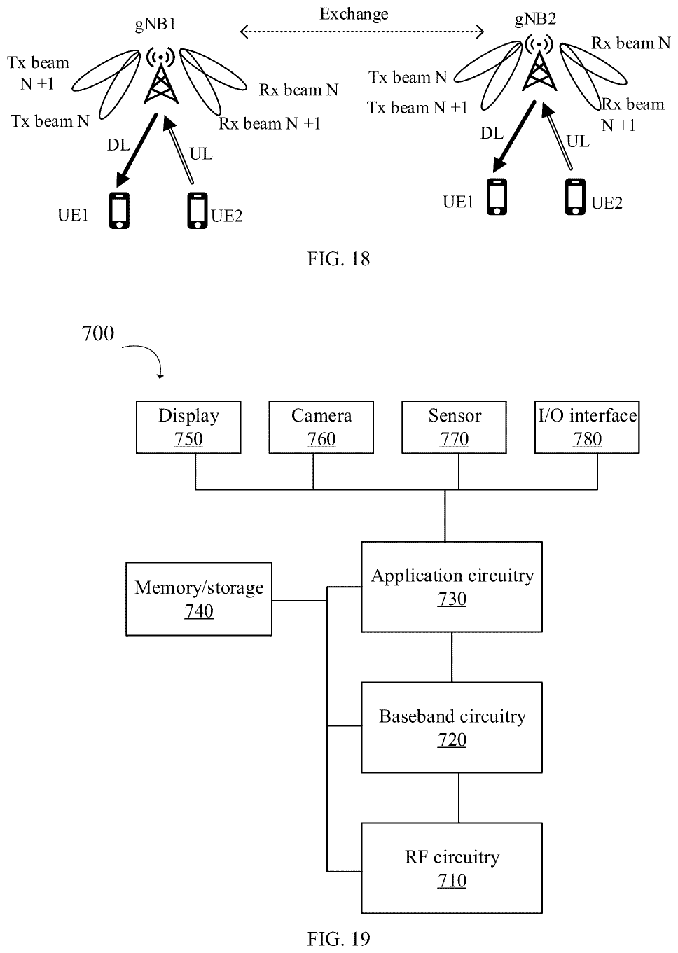

FIG. 18 is a schematic diagram illustrating an example of spatial domain enhancement for dynamic/flexible TDD and SBFD operation according to an embodiment of the present disclosure. FIG. 18 illustrates that this embodiment of the present disclosure discusses the feasibility and potential benefits of spatial domain coordination method for gNB-to-gNB and UE to UE CLI handling which can be specific for dynamic/flexible TDD and/or common for both SBFD and dynamic/flexible TDD. The spatial domain coordination can be applied to all the scenarios which is mentioned in the above embodiments.

In this embodiment, the neighbor gNBs can assign different beams to the DL and UL transmission with possible isolation gap between the DL and UL beams. For instance, the two neighbor's gNBs (which may use TDD operation and/or SBFD operation) can assign Rx beam n, and Rx n+1 to the UL transmission, and Tx beam n and n+1 to the DL transmission, where the Tx and Rx beams of each gNB can be different from each other's. In addition, gNB1 and gNB2, can isolate the UL and DL transmission beams up to the possible extent in order to separate the UL and DL transmissions.

### Relevant Information Exchange

In spatial domain enhancement, the neighbor gNBs need to share the relevant information of the beams which is assigned to the DL transmission and UL transmission with each other. In this way, the neighbor gNBs can adjust their beams according to each other and it may reduce the gNB to gNB and UE to UE CLI.

In summary, the main objective of some embodiments of this disclosure is to minimize or avoid the gNB to gNB CLI and UE to UE CLI, when dynamic/flexible TDD and SBFD operations, are implemented in the same time slots/symbols. The proposed solutions to achieve our objectives are summarized as below.

Coordinated scheduling for time frequency resources, which can be applied to the implementation of dynamic/flexible TDD and SBFD operations in the same time slots, has discussed and several scheduling adaptation solutions have proposed according to different operations scenarios as given below.
Scenario 1: When the neighbor base stations implement dynamic/flexible TDD and SBFD operation respectively in the same time slots.
Scenario 2: When each of the neighbor's base stations implements both dynamic/flexible TDD and SBDF operation in the same time slots.
Scenario 3: When a base station implements both dynamic/flexible TDD and SBFD operation, and a neighbor base station implements only SBFD operation.

Resources blocks muting has been disclosed in order to avoid the transmission of opposite direction in the neighbor gNB and avoid CLI in the above mentioned scenarios.

Time window comprises of slots or symbols has disclosed which may allow gNB to perform both dynamic/flexible TDD and SBFD operations simultaneously.

Coordination for spatial domain has proposed in which the neighbor base station share the relevant information of serving beams for DL transmission and UL reception in order to isolates the Tx and Rx beams, which may reduce the gNB to gNB and UE to UE CLI.

Some embodiments of this disclosure discuss coordinated scheduling for time frequency resources which can be applied to the implementation of dynamic/flexible TDD and SBFD operation in the same time slots/symbols, and have the following advantages.
1. The proposed methods and solutions considers diverse implementation scenarios of dynamic/flexible TDD and SBFD operation in the same time slots in order to avoid the CLI before happening.
2. The propose methods and solutions considers the relevant information exchange among the neighbor base stations according to the implementation scenarios in order to identify the specific information which needs to be exchanged, and avoid the exchange of unnecessary information among the base stations.
3. The proposed methods and solutions consider serving the legacy UEs and Rel-18 UEs simultaneously in order to improve the base station resources utilization.

FIG. 19 is a block diagram of an example system 700 for wireless communication according to an embodiment of the present disclosure. Embodiments described herein may be implemented into the system using any suitably configured hardware and/or software. FIG. 19 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of coordinated scheduling for time frequency resources of dynamic/flexible time division duplex (TDD) operation and/or sub-band full duplex (SBFD) operation, comprising:
in a coordinated scheduling of a dynamic/flexible TDD and/or SBFD operation in same time slots/symbols, at least two neighbor base stations exchanging a relevant scheduling information with each other, wherein the relevant scheduling information comprises a starting and a number of downlink (DL) and/or uplink (UL) slot formats, a starting and a number of resource blocks (RBs) for DL and/or UL sub-bands, and/or a time window assigned to the dynamic/flexible TDD and/or SBFD operation; and
implementing, by the at least two neighbor base stations, a scheduling adaptation according to the relevant scheduling information.

2-4. (canceled)

5. The method according to claim 1, wherein a first base station of the at least two neighbor base stations is configured to perform DL transmission in the same time slots/symbols, and a second base station of the at least two neighbor base stations is configured to perform DL and UL transmissions using DL and UL sub-bands in the same time slots/symbols, and implementing the scheduling adaptation comprises at least one of the followings:
wherein the first base station is configured to mute or halt the number of RBs which corresponds to the RBs of the UL sub-band of at least one neighbor base station; and
wherein the second base station is configured to assign more sub-bands resources to a DL sub-band transmission to minimize a number of muting RBs at the first base station, wherein the muted or halted RBs are used for UL transmission or sounding reference signals in case the at least two neighbor base stations supports both the dynamic/flexible TDD and SBFD operation.

6. The method according to claim 1, wherein a first base station of the at least two neighbor base stations is configured to perform UL transmission in the same time slots/symbols, and a second base station of the at least two neighbor base stations is configured to perform DL and UL transmissions in the same time slots/symbols for the SBFD operation, and implementing the scheduling adaptation comprises at least one of the followings:
wherein the second base station is configured to mute or halt the number of RBs which corresponds to the RBs of the DL sub-band at the first base station; and
wherein the second base station is configured to assign more sub-bands resources to an UL sub-band transmission to minimize a number of muting RBs at the first base station.

7. The method according to claim 1, wherein the at least two neighbor base stations are configured to implement both the dynamic/flexible TDD operation and the SBFD operation in the same flexible time slots/symbols.

8. The method according to claim 7, wherein each of the at least two neighbor base stations uses time windows for each of the dynamic/flexible TDD operation and the SBFD operation, and the relevant scheduling information comprises:
X slots or Y orthogonal frequency division multiplexing (OFDM) symbols in a first time window and X slots or Y OFDM symbols in a second time window;
a time window assignment to both the dynamic/flexible TDD operation and the SBFD operation; and/or
a staring and a number of RBs for DL and UL sub-bands in a time window which is assigned to the SBFD operation.

9. The method according to claim 8, wherein if the at least two neighbor base stations perform the dynamic/flexible TDD operation in the same transmission direction, implementing the scheduling adaptation comprises at least one of the followings:
wherein a first base station of the at least two neighbor base stations is configured to assign the first time window to the dynamic/flexible TDD operation and the second time window to the SBFD operation, and
wherein a second base station of the at least two neighbor base stations is configured to assign the first time window to the dynamic/flexible TDD operation and the second time window to the SBFD operation.

10. The method according to claim 8, wherein if the at least two neighbor base stations perform the dynamic/flexible TDD operation in different transmission directions, implementing the scheduling adaptation comprises at least one of the followings:
wherein a first base station of the at least two neighbor base stations is configured to assign the first time window to the dynamic/flexible TDD operation and the second time window to the SBFD operation, and
wherein a second base station of the at least two neighbor base stations is configured to assign the first time window to the SBFD operation and the second time window to the dynamic/flexible TDD operation.

11. The method according to claim 10, wherein the first base station is configured to assign more sub-bands resources to the DL direction in the first time window and mute or halt the RBs in the first time window which corresponds to the UL sub-band direction at the second base station, and/or
wherein the second base station is configured to assign more sub-bands resources to the UL direction in the first time window and mute or halt those RBs in the second time window which corresponds to the DL sub-bands at the first base station.

12-13. (canceled)

14. The method according to claim 1, wherein the dynamic/flexible TDD operation at the first base station of the at least two neighbor base stations is in the DL direction, implementing the scheduling adaptation comprises at least one of the followings:
wherein the first base station is configured to assign the first time window to the dynamic/flexible TDD operation and the second time window to the SBFD operation and/or the first base station is configured to mute or halt the number of RBs in the first time window which corresponds to the UL sub-band direction at the second base station, and
wherein the second base station is configured to assign sub-bands resources to the DL direction.

15. The method according to claim 1, wherein the dynamic/flexible TDD operation at the first base station is in the UL direction, implementing the scheduling adaptation comprises at least one of the followings:
wherein the first base station is configured to assign the first time window to the dynamic/flexible TDD operation and the second time window to the SBFD operation and/or the first base station is configured to mute or halt the number of RBs in the first time window which corresponds to the DL sub-band direction at the second base station, and
wherein the second base station is configured to assign sub-bands resources to the UL direction.

16-17. (canceled)

18. The method according to claim 1, wherein when the muting or halting RBs are invisible/transparent to UEs, muting or halting the RBs in the dynamic/flexible TDD operation is through a resource allocation type 1, where an RB_start of the resource allocation type 1 is adjusted according to the relevant scheduling information received from the second base station.

19. The method according to claim 1, wherein when the muting or halting RBs are visible/non-transparent to the UEs, muting or halting the RBs in the dynamic/flexible TDD operation is through a resource allocation type 0, where a bitmap is used to indicate resource block groups (RBGs).

20. The method according to claim 19, wherein the base station is used to configure all the RBs to the UE and send an indication to inform the UE that a number of RBs or resource block groups (RBGs) cannot be use for transmission.

21. The method according to claim 1, wherein the time window comprises slots/symbols to allow the first base station to perform the dynamic/flexible TDD operation and/or the SBFD operation, and/or the time window is periodic or aperiodic.

22. The method according to claim 21, wherein the time window comprises a slot based time window or a symbol based time window.

23. The method according to claim 22, wherein the slot based time window comprises a reference point and a duration, the reference point of the slot based time window is determined by a slot-level offset form a start of a sub-frame which is associated with the slot based time window, and the duration is a number of slots until which the slot based time window is effective.

24. The method according to claim 22, wherein the symbol based time window comprises a reference point and a duration, the reference point of the symbol based time window is determined by a symbol-level offset from a start of a sub-frame which is associated with the symbol based time window, and the duration is a number of symbols until which the symbol based time window is effective.

25. The method according to claim 22, wherein a configuration of the time window for the dynamic/flexible TDD operation and/or the SBFD operation is performed by using an RRC signaling.

26. The method according to claim 1, further comprising performing coordination for spatial domain in which the base station and the at least neighbor base station share the relevant scheduling information of serving beams for DL transmission and UL reception to isolates the transmission and reception beams.

27. A base station, comprising:
a memory;
a transceiver; and
a processor coupled to the memory and the transceiver;
wherein the processor is configured to execute a method of coordinated scheduling for time frequency resources of dynamic/flexible time division duplex (TDD) operation and/or sub-band full duplex (SBFD) operation, comprising:
in a coordinated scheduling of a dynamic/flexible TDD and/or SBFD operation in same time slots/symbols, at least two neighbor base stations exchanging a relevant scheduling information with each other, wherein the relevant scheduling information comprises a starting and a number of downlink (DL) and/or uplink (UL) slot formats, a starting and a number of resource blocks (RBs) for DL and/or UL sub-bands, and/or a time window assigned to the dynamic/flexible TDD and/or SBFD operation; and
implementing, by the at least two neighbor base stations, a scheduling adaptation according to the relevant scheduling information.

28-32. (canceled)
